(19) United States
(12) Patent Application Publication
(10) Pub. No.: US 2006/0228099 A1
(43) Pub. Date: Oct. 12, 2006

(54) Digital camera with electromagnetic focusing module

(75) Inventor: Tsung-Wei Chiang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/391,992

(22) Filed: Mar. 28, 2006

(30) Foreign Application Priority Data
Apr. 8, 2005 (CN) 200520057008.8

(51) Int. Cl. G03B 13/34

(52) U.S. Cl. 396/133

(57) ABSTRACT

A digital camera (100) includes a lens barrel (10), an image sensor (14), a focus driving system (16), and a holder (18). The lens barrel is slidably disposed in the holder. The image sensor is secured on the holder. The focus driving system includes a first driving element and a second driving element. The first driving element is secured on the lens barrel, and the second driving element is secured on the holder according to the first driving element, either the first driving element or the second driving element is an electromagnet, and the other is a magnet element so as to make magnetic interact with the electromagnet.

### BACKGROUND OF THE INVENTION

1. Field of the Invention

The present invention generally relates to focusing modules used in photography and imaging equipment and, more particularly, to a focusing module for a digital camera.

2. Discussion of the Related Art

Currently, digital camera modules are included as a feature in a wide variety of portable electronic devices and, of course, in stand-alone digital camera units. Most portable electronic devices are becoming progressively more miniaturized over time, and digital camera modules are correspondingly becoming smaller and smaller. However, due to this increasing miniaturization their image quality has been effected and manufacturers have tried to develop devices to overcome this.

In most typical photography and imaging equipment focus adjusting mechanisms are used to facilitate the taking of high quality photos. A focus adjusting mechanism typically includes a motor and a driving member. However, the focus adjusting mechanism cannot be effectively used in a miniature digital camera module for a portable electronic device, because the motor and the driving member need rather a large space to adjust focus.

Automatic focusing modules for miniature digital camera modules typically include a magnetic coil, a magnetic element and a spring. An image sensor is defined in an image sensor package. The magnetic element is secured on the upper portion of the image sensor. One end of the spring is attached to the lower portion of the image sensor. The other end of the spring is attached to the image sensor package. When the automatic focusing module performs its focusing function, a microprocessor controls an electric current introduced into the magnetic coil. The magnetic coil subsequently produces a magnetic field, which has an opposite direction to a magnetic polarity of the magnetic element. The repulsive force between the magnetic coil and the magnetic element will drive the image sensor to compress the spring. Correspondingly, a compression distance of the spring depends on the amount of the electric current. Thus, the automatic focusing module achieves the focusing function by controlling the compression distance/amount of the spring. Finally, once the introduction of the electric current into the magnetic coil is stopped, the spring will decompress, and the image sensor will return to an initial position.

However, such an automatic focusing module has a complex structure, incorporating the magnetic coil, the magnetic element, and the spring. Moreover, the image sensor package needs to be precisely designed to effectively employ the compression distance of the spring for focus control.

Therefore, a new focusing module is desired in order to overcome the above-described shortcomings.

### SUMMARY

A digital camera includes a lens barrel, an image sensor, a focus driving system, and a holder. The lens barrel is slidably disposed in the holder. The image sensor is secured on the holder. The focus driving system includes a first driving element and a second driving element. The first driving element is secured on the lens barrel, and the second driving element is secured on the holder according to the first driving element. Furthermore, either the first driving element or the second driving element is an electromagnet, and the other is a magnet element so as to make magnetic interact with the electromagnet.

Other novel features will become more apparent from the following detailed description when taken in conjunction with the accompanying drawings.

### BRIEF DESCRIPTION OF THE DRAWINGS

Many aspects of the present digital camera and the focusing module thereof can be better understood with reference to the following drawings. The components in the drawings are not necessarily drawn to scale, the emphasis instead being placed upon clearly illustrating the principles of the present digital camera. Moreover, in the drawings, like reference numerals designate corresponding parts throughout the several views.

FIG. 1 is a schematic view of a digital camera in accordance with a first embodiment, showing an initial state;

FIG. 2 is a schematic view of the digital camera in FIG. 1, showing a focusing state,

FIG. 3 is a schematic view of a digital camera in accordance with a second embodiment, showing an initial state, and

FIG. 4 is a schematic view of the digital camera in FIG. 3, showing a focusing state.

### DETAILED DESCRIPTION OF THE EMBODIMENTS

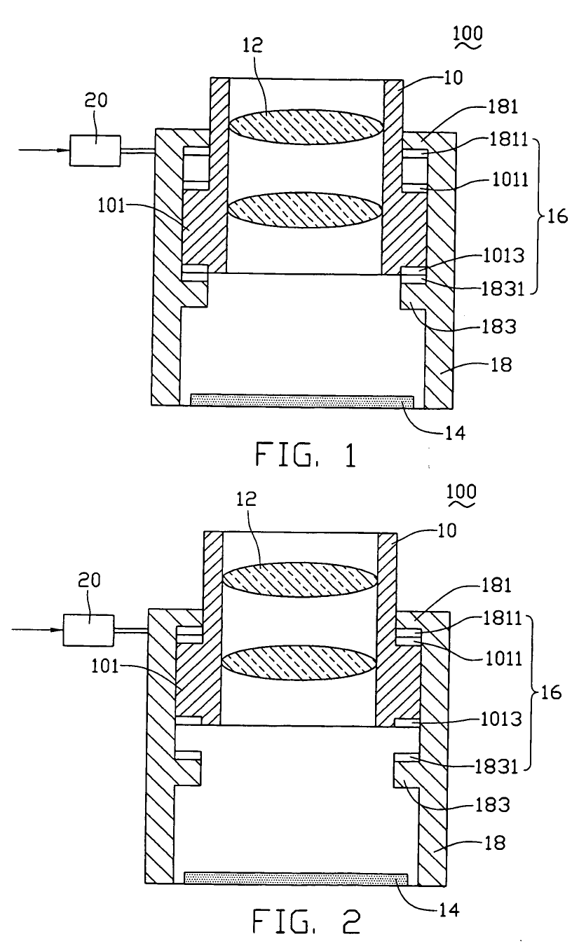

Referring to FIGS. 1 and 2, a digital camera 100 according to a first embodiment of the present invention includes a lens barrel 10, a lens module 12, an image sensor 14, a focus driving system 16, and a holder 18. The lens barrel 10 and the image sensor 14 are received in the holder 18, separate from each other.

The lens barrel 10 is a substantially hollow cylinder and receives the lens module 12 therein. In the illustrated embodiment, the lens module 12 includes two lenses, but it is to be understood that any various number and types of known lenses could be used in the lens module 12. A protuberance 101 is formed on the outer peripheral wall of the lens barrel 10. A first driving element 1011 and a second driving element 1013, which are part of the focus driving system 16, are secured on the protuberance 101.

The image sensor 14 is configured for converting an image signal to an electronic signal. The image sensor 14 may, for example, be a Complementary Metal-Oxide Semiconductor (CMOS) type sensor or a Charge Coupled Device (CCD).

The holder 18 is also a substantially hollow cylinder, having a first end and an opposite second end. The lens barrel 10 is disposed at the first end of the holder 18, and the image sensor 14 is secured within the second end of the holder 18. The holder 18 has an inner diameter slightly larger than the outer diameter of the lens barrel 10, so that the lens barrel 10 can slide in the holder 18. A first limiting portion 181 and a second limiting portion 183 are separately disposed on the inner peripheral wall of the holder 18 to provide a limit on the potential range of motion of the lens barrel 10. By acting to limit movement of the lens barrel 10, the first limiting portion 181 and the second limiting portion 183 can protect other elements in the holder 18 from being damaged by movement of the lens barrel 10.

The focus driving system 16, as illustrated, incorporates further driving elements. Particularly, a third driving element 1811 is mounted on the first limiting portion 181, according to the first driving element 1011 of the lens barrel 10. A fourth driving element 1831 is mounted on the second limiting portion 183, according to the second driving element 1013 of the lens barrel 10.

At least one of the first driving element 1011, the second driving element 1013, the third driving element 1811 and the fourth driving element 1831, which collectively establish the focus driving system 16, is an electromagnet, and the others are magnetic elements, each, for example, being an electromagnet or a permanent magnet.

In the illustrated embodiment, the third driving element 1811 is an electromagnet connected to an electric circuit 20. The electric circuit 20 provides an alterable/adjustable electric current to the third driving element 1811. The third driving element 1811 generates a magnetic field under the electric current. The magnetic field can be chosen so as to either attract or repel the first driving element 1011. Thus, the magnetic field can drive the lens barrel 10 to axially move between the first limiting portion 181 and the second limiting portion 183, without rotating relative to the holder 18. Because the lens module 12 moves together with the lens barrel 10, an image distance between the lens module 12 and the image sensor 14 will change with the movement of the lens barrel 10. Therefore, the focus driving system 16 and thus the digital camera 100 completes a focusing process.

In the illustrated embodiment, the first driving element 1011, the second driving element 1013, and the fourth driving element 1831 are all annular permanent magnets, and polarities of the second driving element 1013 and the fourth driving module 1831 are opposite to one another, and, thus the second driving element 1013 is attracted by the fourth driving element 1831. Referring to FIG. 1, in the initial status, the electric circuit 20 does not provide an electric current to the third driving element 1811. At this time, the second driving element 1013 touches the fourth driving element 1831 because the attractive force therebetween, and the protuberance 101 of the lens barrel 10 is adjacent to the second limiting portion 183. Thus, the digital camera 100 gets a first image distance between the lens module 12 and the image sensor 14.

Referring to FIG. 2, when the digital camera 100 cannot obtain a satisfactory image-quality in the initial status with the initial image distance, the electric circuit 20 provides an electric current to the third driving element 1811. The third driving element 1811 produces a magnetic field under the alterable electric current. The attractive force between the third driving element 1811 and the first driving element 1011 is larger than that between the second driving element 1013 and the fourth driving element 1831. Accordingly, the attractive force drives the first driving element 1011 to move toward the third driving element 1811. When the first driving element 1011 touches the third driving element 1811, and the protuberance 101 of the lens barrel 10 is adjacent to the first limiting portion 181, the digital camera 100 gets a second image distance between the lens module 12 and the image sensor 14. The digital camera 100 can obtain good image quality with the second image distance. When the focus driving system 16 and thus the digital camera 100 completes a focusing process (for example, after capturing an image; choosing a different focus; etc.), the electric circuit 20 stops providing the electric current to the third driving element 1811, and the digital camera 100 returns to the initial status. It is also to be understood that the step of stopping the electrical current may be gradually performed to permit a controlled return to the initial status position. It is further to be understood that the electric circuit 20 could potentially be controlled so as to allow an intermediate focus position to be achieved (i.e., between the first and second image distances).

It is to be understood that polarities of the second driving element 1013 and the fourth driving module 1831 may be the same, thus the second driving element 1013 is repelled by the fourth driving element 1831. In such a state, FIG. 2 would represent an initial status, with the electric circuit 20 not provide the electric current to the third driving element 1811. At this time, the first driving element 1011 touches the third driving element 1811 because the repulsive force between the second driving element 1013 and the fourth driving element 1831, and the protuberance 101 of the lens barrel 10 is adjacent to the first limiting portion 181. Thus, the digital camera 100 gets a first image distance between the lens module 12 and the image sensor 14. Referring to FIG. 1, when the electric circuit 20 provides an opposite electric current to the third driving element 1811. The third driving element 1811 produces a magnetic field under the alterable electric current. The repulsive force between the third driving element 1811 and the first driving element 1011 is larger than that between the second driving element 1013 and the fourth driving element 1831. As such, the repulsive force drives the second driving element 1013 to move toward the fourth driving element 1831. When the second driving element 1013 touches the fourth driving element 1831 and the protuberance 101 of the lens barrel 10 is adjacent to the second limiting portion 183, the digital camera 100 gets a second image distance between the lens module 12 and the image sensor 14. When the digital camera 100 completes a focusing process, the electric circuit 20 stops providing the electric current to the third driving element 1811, and the digital camera 100 returns to the initial status.

In one embodiment, it is to be understood that either the first driving element 1011 or the third driving element 1811 is an electromagnet, and the other is a magnetic metal, for example, an iron or a steel. Either the second driving element 1013 or the fourth driving element 1831 is a magnetic element, for example, an electromagnet or a permanent magnet, and the other is a magnetic metal, for example, an iron or a steel. The lens barrel 10 can move toward the first limiting portion 181 or the second limiting portion 183 of the holder 18, an image distance between the lens module 12 and the image sensor 14 is variety Thus, the digital camera 100 completes a focusing process.

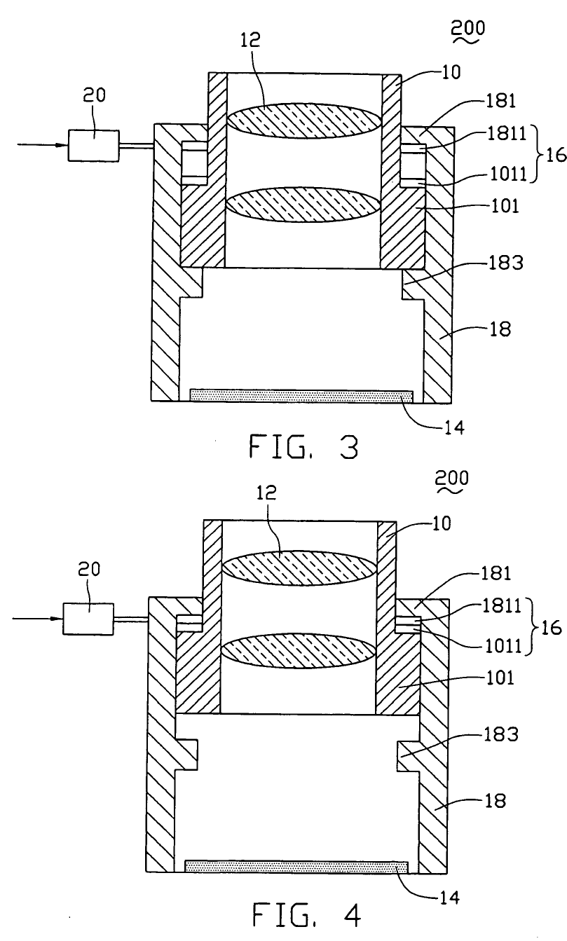

Referring to FIGS. 3 and 4, a digital camera 200 according to a second embodiment of the present invention is shown. Most of the structure of the digital camera 200 of the second embodiment is similar to that of the digital camera 100 of the first embodiment, except that the second driving element 1013 and the fourth driving element 1831 can be omitted. Either the first driving element 1011 or the third driving element 1811 is an electromagnet, and the other is a magnetic element, for example, an electromagnet or a permanent magnet. In the illustrated embodiment, the third driving element 1811 is an electromagnet, and the first driving element 1011 is a permanent magnet. In initial status, the electric circuit 20 does not provide the electric current to the third driving element 1811. At this time, the protuberance 101 of the lens barrel 10 touches the second limiting portion 183. Thus, the digital camera 200 gets a first image distance between the lens module 12 and the image sensor 14. When the electric circuit provides an electric current to the third driving element 1811, the attractive force drives the first driving element 1011 to move toward the third driving element 1811. When the first driving element 1011 touches the third driving element 1811, and the protuberance 101 of the lens barrel 10 is adjacent to the first limiting portion 181, the digital camera 200 gets a second image distance between the lens module 12 and the image sensor 14. When the digital camera 200 completes a focusing process, the electric circuit 20 stops providing the electric current to the third driving element 1811, and the digital camera 200 returns to the initial status. Also, it is to be understood that the first driving element 1011 and the third driving element 1811 can be omitted, and either the second driving element 1013 or the fourth driving element 1831 is an electromagnet, and the other is a magnetic element, for example, an electromagnet or a permanent magnet.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A digital camera, comprising:
a holder having a first end and an opposite second end;
a lens barrel slidably disposed at the first end of the holder;
an image sensor located at the second end of the holder; and
a focus driving system comprising a plurality of driving elements including a first driving element and a second driving element;
wherein, the first driving element is mounted on the lens barrel, a second driving element is mounted on the holder according to the first driving element, one of the first driving element and the second driving element is an electromagnet, and the other is a magnet element so as to make magnetic interact with the electromagnet.

2. The digital camera as claimed in claim 1, wherein the first driving element is the electromagnet, the electromagnet is connected to an electric circuit, and the second driving element is the magnetic element.

3. The digital camera as claimed in claims 2, wherein the magnetic element is a permanent magnet.

4. The digital camera as claimed in claim 1, wherein the second driving element is the electromagnet, the electromagnet is connected to an electric circuit, and the first driving element is the magnetic element.

5. The digital camera as claimed in claims 4, wherein the magnetic element is a permanent magnet.

6. The digital camera as claimed in claim 1, wherein the lens barrel is a hollow cylinder and receives a lens module therein.

7. The digital camera as claimed in claim 6, wherein a protuberance is formed on an outer peripheral wall of the lens barrel, the first driving element is secured on the protuberance.

8. The digital camera as claimed in claim 7, wherein the focus driving system further comprises a third driving element secured on the protuberance.

9. The digital camera as claimed in claim 8, wherein the holder has a first limiting portion and a second limiting portion, and the second driving element is secured on the first limiting portion of the holder.

10. The digital camera as claimed in claim 9, wherein the focus driving system further comprises a fourth driving element secured on the second limiting portion of the holder according to the third driving element.

11. The digital camera as claimed in claim 10, wherein the first driving element is the electromagnet, the electromagnet is connected to an electric circuit, and the second driving element, the third driving element and the fourth driving element are all magnetic elements.

12. The digital camera as claimed in claim 11, wherein the magnetic element is a permanent magnet.

13. The digital camera as claimed in claim 10, wherein the second driving element is the electromagnet, the electromagnet is connected to an electric circuit, and the first driving element, the third driving element and the fourth driving element are all magnetic elements.

14. The digital camera as claimed in claim 13, wherein the magnetic element is a permanent magnet.

15. A digital camera module comprising:
a holder being a hollow member and having an axis;
a lens barrel slidably received in the holder, the lens barrel having at least one lens installed therein;
a first driving element arranged on the holder; and
a second driving element arranged on the lens barrel, the first and second driving elements being magnetically engagable so as to move the lens barrel along the axis.

16. The digital camera module as claimed in claim 15, wherein the first and second driving elements are engaged so as to drive the lens barrel to axially move without causing rotation of the lens barrel relative to the holder.

17. The digital camera module as claimed in claim 15, wherein a protuberance is formed on an outer peripheral wall of the lens barrel, the first driving element is secured on the protuberance.

18. The digital camera module as claimed in claim 17, wherein the holder has a first limiting portion and a second limiting portion cooperatively defining a travel for the lens barrel, and the second driving element is secured on the first limiting portion of the holder.
